(19) United States
(12) Patent Application Publication
(10) Pub. No.: US 2025/0078492 A1
(43) Pub. Date: Mar. 6, 2025

(54) METHOD, APPARATUS, DEVICE AND STORAGE MEDIUM OF TARGET SEGMENTATION

(71) Applicants: Douyin Vision Co., Ltd., Beijing (CN); Lemon Inc., Grand Cayman (KY)

(72) Inventors: Gen ZHAN, Beijing (CN); Yabin ZHANG, Beijing (CN); Yiting LIAO, Los Angels, CA (US); Junlin LI, Los Angeles, CA (US)

(21) Appl. No.: 18/819,980

(22) Filed: Aug. 29, 2024

(30) Foreign Application Priority Data
Aug. 29, 2023 (CN) 202311102725.7

(51) Int. Cl. G06V 10/94; G06F 3/01; G06V 10/26; G06V 20/70

(52) U.S. Cl. CPC G06V 10/945; G06V 10/26; G06V 20/70; G06F 3/012; G06F 3/013

(57) ABSTRACT

The embodiments of the disclosure provides a method, apparatus, device and storage medium of target segmentation. The method includes: determining location information of a current viewpoint when a target user watches a target object; performing target segmentation on the target object at location of a viewpoint based on location information of a current viewpoint and a visual foundation model, to determine and present a current segmentation result; and in response to a segmentation end operation triggered by the target user for the current segmentation result, taking the current segmentation result as a target segmentation result corresponding to the target object. According to the technical solution of the embodiments of the disclosure, any target may be real-time segmented, meeting a user segmentation requirement, and the accuracy and efficiency of target segmentation are ensured.

### CROSS-REFERENCE TO RELATED APPLICATIONS

The present application claims priority to Chinese Patent Application No. 202311102725.7, entitled “METHOD, APPARATUS, DEVICE AND STORAGE MEDIUM OF TARGET SEGMENTATION,” filed on Aug. 29, 2023, the contents of which are hereby incorporated by reference in its entirety.

### FIELD

The embodiments of the present disclosure relate to the technical field of computers, and, more particular, to a method, apparatus, device and storage medium of target segmentation.

### BACKGROUND

With the rapid development of computer technologies, performing identification segmentation on a target in an image is often necessary. At present, the network model is usually trained by using a segmentation mask image mask of a specific target, and performing segmentation on a specific target in the image by using the network model after training. However, the target after a segmentation in this manner is fixed and changeless, and if other targets need to be segmented, the network model needs to be further trained. It can be seen that a segmentation manner capable of real-time segmenting any target is currently urgent needed.

### SUMMARY

The present disclosure provides a method, apparatus, device and storage medium of target segmentation, to real-time segment any target, to meet a user segmentation requirement, and the accuracy and efficiency of target segmentation are ensured.

In a first aspect, the embodiments of the present disclosure provide a method of target segmentation, comprising:
Determining location information of a current viewpoint when a target user watches a target object;
Performing target segmentation on the target object at location of a viewpoint based on location information of a current viewpoint and a visual foundation model, to determine and present a current segmentation result;
In response to a segmentation end operation triggered by the target user for the current segmentation result, taking the current segmentation result as a target segmentation result corresponding to the target object.

In a second aspect, the embodiments of the present disclosure further provide an apparatus of target segmentation, comprising:
A viewpoint information determining module, configured to determine location information of a current viewpoint when a target user watches a target object;
A target segmentation module, configured to perform target segmentation on the target object at location of a viewpoint based on location information of a current viewpoint and a visual foundation model, to determine and present a current segmentation result;
A segmentation end module, configured to, in response to a segmentation end operation triggered by the target user for the current segmentation result, take the current segmentation result as a target segmentation result corresponding to the target object.

In a third aspect, embodiments of the present disclosure further provide an electronic device, comprising:
One or more processors;
A storage apparatus, configured to store one or more programs, wherein the one or more programs, when executed by the one or more processors, cause the one or more processors to implement the method of target segmentation according to any one of the embodiments of the present disclosure.

In a fourth aspect, embodiments of the present disclosure further provide a storage medium comprising computer-executable instructions, wherein the computer-executable instructions, when executed by a computer processor, are configured to perform the method of target segmentation according to any one of the embodiments of the present disclosure.

According to the embodiments of the present disclosure, location information of a current viewpoint when a target user watches a target object is determined, so that the target which the target user currently want to segment is obtained based on the location information of the current viewpoint point. The target segmentation at location of a viewpoint nay be accurately performed based on the visual foundation model, and a current segmentation result is presented to the target user. When the target user is satisfied with the presented current segmentation result, a segmentation end operation may be triggered, and in response to the segmentation end operation, the current segmentation result may be taken as the final target segmentation result of the target object, so that any target that the user wants to segment is real-time segmented, which meets the user segmentation requirement, and the user only needs to watch the target object, there is no need for the user to perform operations such as manual clicking, thereby improving the efficiency of target segmentation.

### BRIEF DESCRIPTION OF DRAWINGS

The above and other features, advantages, and aspects of various embodiments of the present disclosure will become more apparent in combination with the accompanying drawings and with reference to the following detailed description. Throughout the drawings, the same or similar reference symbols refer to the same or similar elements. It should be understood that the drawings are schematic, and elements are not necessarily drawn to scale.

FIG. 1 is a schematic flowchart of a method of target segmentation provided by embodiments of the present disclosure;

FIG. 2 is an example architecture of a visual foundation model involved in embodiments of the present disclosure;

FIG. 3 is a schematic flowchart of another method of target segmentation provided by embodiments of the present disclosure;

FIG. 4 is an example data flow of a target progressive segmentation involved in embodiments of the present disclosure;

FIG. 5 is an example diagram of a target progressive segmentation involved in embodiments of the present disclosure;

FIG. 6 is a schematic structural diagram of an apparatus of target segmentation provided by embodiments of the present disclosure;

FIG. 7 is a schematic structural diagram of an electronic device provided by embodiments of the present disclosure.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure may be implemented in various forms, and should not be interpreted as limited to the embodiments set forth herein. On the contrary, these embodiments are provided for a more thorough and complete understanding of the present disclosure. It should be understood that the accompanying drawings and embodiments of the present disclosure are only for exemplary purposes and are not intended to limit the scope of protection of the present disclosure.

It should be understood that the various steps recited in the implement method of the present disclosure may be performed in different orders, and/or in parallel. Furthermore, the implement method may include additional steps and/or omit the steps shown by performing. The scope of the present disclosure is not limited in this respect.

As used herein, the term “comprising” and its variations would be appreciated as open inclusion, i.e., “including but not limited to”. The term “based on” represents “at least partially based on”. The term “one embodiment” represents “at least one embodiment”; the term “another embodiment” represents “at least one further embodiment”; the term “some embodiments” represents “at least some embodiments”. The related definition of other terms would be included in the following descriptions.

It should be noted that concepts such as “first” and “second” mentioned in the present disclosure are only used for distinguishing different apparatuses, modules, or units, and are not used for limiting the order of functions performed or the relation of interdependence of the apparatuses, modules, or units.

It should be noted that the modification of “one” and “a plurality of” mentioned in the present disclosure is illustrative and not limiting, and those skilled in the art should understand it as “one or more” unless the context clearly indicates.

The names of messages or information interacted between a plurality of apparatuses in the embodiments of the present disclosure are for illustrative purposes only and are not used to limit the scope of these messages or information.

It may be understood that the data involved in the present technical solution (including but not limited to the data itself, the obtaining or using of the data) should follow the requirements of the corresponding laws and regulations and related provision.

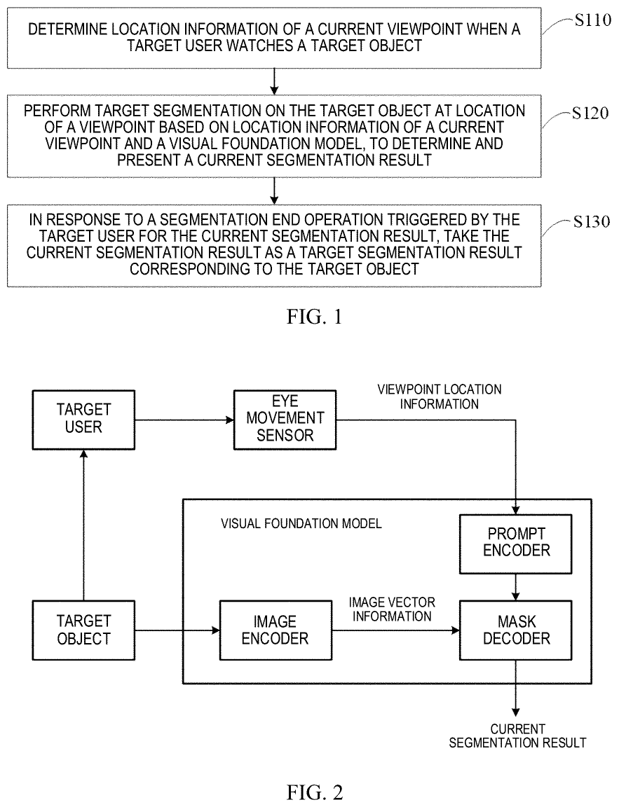

FIG. 1 is a schematic flowchart of a method of target segmentation provided by embodiments of the present disclosure, and the embodiments of the present disclosure are applicable to a case of performing segmentation on the object viewed by a user in an image or a video, and the method may be performed by an apparatus of target segmentation, and the apparatus may be implemented in a form of software and/or hardware, optionally, implemented by an electronic device, and the electronic device may be a mobile terminal, a PC terminal or a server.

As shown in FIG. 1, the method of target segmentation specifically comprises the following steps:
S110: Determine location information of a current viewpoint when a target user watches a target object.

The target user may refer to any user viewing the target object. The target object may be an object which needs to be segmented currently. For example, the target object may be an image or a video that needs to be segmented currently. The target image may also refer to a sample image, that is, an image used for model training. The location information of the current viewpoint may refer to an image location point aligned with the sight line of the target user at the current moment. The location information of the current viewpoint may be used to represent location information of the target that the target user wants to segment currently. The location information of the current viewpoint may be any location information in the target object, that is, the target to be segmented may refer to any item in the target object.

Specifically, when the target user watches the target object, the sight line is viewed to the target location which wants to be segmented currently, and the location information of the current viewpoint of the target user may be real-time determined by using any viewpoint positioning manner.

Exemplarily, S110 may comprise: obtaining current eye movement information or current head movement information when the target user watches the target object via a wearable device; and determining, based on the current eye movement information or the current head movement information, location information of a current viewpoint of the target user.

The wearable device may refer to a device for collecting eye movement information or head movement information of the user which is worn by the user. For example, the wearable device may refer to a head-mounted device worn on user's head. The wearable device may refer to an eye tracker device or a VR device, etc.

Specifically, the wearable device has a head-mounted display, the target object may be input into the wearable device and displayed on the head-mounted display, so that the target user may view the target object via the head-mounted display. As shown in FIG. 2, during the process of the target user viewing the target object, the current eye movement information or the current head movement information of the target user may be collected in real time by a location tracking apparatus such in the wearable device, such as an eye movement sensor, the current eye movement information or the current head movement information is converted into the pixel coordinates in the image coordinate system, thereby obtaining the location information of the current viewpoint of the target user. It should be noted that the location information of the current viewpoint of the target user may be more accurately positioned based on the current eye movement information of the target user.

Exemplarily, before using the wearable device, the wearable device needs to be calibrated, so as to ensure accuracy of the target segmentation. For example, the target user may follow the prompt to view the data anchor appearing on the screen, to complete the mapping and calibration of the position relationship between location tracking apparatuses such as the eye movement sensor and the screen.

S120, perform target segmentation on the target object at location of a viewpoint based on location information of a current viewpoint and a visual foundation model, to determine and present a current segmentation result.

The visual foundation model may refer to a foundation model with image segmentation capability which is obtained by preforming pre-training on a large-scale data set. The visual foundation model may be a pre-trained interactive segmentation model, so as to perform target segmentation based on the prompt information. For example, the visual foundation model may refer to a large visual model such as a Segment Anything Model (SAM) or a Segment Everything Everywhere All at Once (SEEM). The visual foundation model is pre-trained on a large amount of label data, which has good generalization and robustness, and may adapt to downstream tasks in various subdivision scenarios. The current segmentation result may refer to a target segmentation result viewed by the target user currently. The current segmentation result may refer to an image matting of a target segmented currently in the target object, or may refer to a target mask image which has a same size with the target object. For example, if there is one little cat in the target object, and the current viewpoint location of the target user is at the little cat, then the current segmentation result is an image matting or mask image mask of the little cat.

Specifically, the target object and the location information of current viewpoint are input into the pre-trained obtained visual foundation model to perform target segmentation at location of the viewpoint, and the current segmentation result of the target object is obtained based on the output of the visual foundation model. It should be noted that, if the target object is an image, then the image and the location information of the current viewpoint may be directly input into the pre-trained obtained visual foundation model to perform target segmentation on the image at the location of the viewpoint. If the target object is a video, the video frame viewed by the target user at current moment in the video and the location information of the current viewpoint may be input into the pre-trained obtained visual foundation model to perform target segmentation on the video frame at the location of the viewpoint.

The visual foundation model may take the input location information of the current viewpoint as the prompt information of the current segmentation point to determine the target location in the target object and perform corresponding segmentation, and output the result after segmenting, thereby realizing interactive automatic segmentation. The visual foundation model may directly output a final current segmentation result of the target object, or may output a plurality of candidate segmentation results and a segmentation quality score corresponding to each candidate segmentation result, at this time, the segmentation result to be selected with the highest segmentation quality score may be taken as the final current segmentation result of the target object. The segmentation quality score may be used to represent completeness and edge uniformity of the segmentation result. After obtaining the current segmentation result, the current segmentation result needs to be presented to the target user, so that the target user views to confirm whether the current segmentation result is a desired and accurate segmentation result.

Exemplarily, as shown in FIG. 2, the visual foundation model may include an image encoder, a prompt encoder, and a mask decoder. The specific segmentation process in the visual foundation model is: inputting the target object into the image encoder, inputting the location information of the current viewpoint of the target user into the prompt encoder, encoding the input target object into image vector information of the high-dimensional feature space in the image encoder, and encoding the input location information of current viewpoint into corresponding prompt point vector information in the prompt encoder. The image vector information and the prompt point vector information are input into the mask decoder for decoding, and a target at location of the viewpoint in the target object is determined and segmented, and a current segmentation result of the target object after segmenting is output.

Exemplarily, “present a current segmentation result” in S120 may comprise: labeling the current segmentation result in the target object presented by the wearable device.

Specifically, since the target object is being presented in the wearable device, the current segmentation result may be directly labeled in the presented target object in real time, for example, the current segmentation result is labeled in the target object in a highlight form or a grayscale form, so as to highlight the current segmentation result, so that the target user may intuitively and clearly view the current segmentation result in the target object, thereby visually presenting the current segmentation result in the target object which is watched currently.

S130: in response to a segmentation end operation triggered by the target user for the current segmentation result, take the current segmentation result as a target segmentation result corresponding to the target object.

The segmentation end operation may be triggered by performing a predetermined eye movement or a predetermined gesture action by the target user. The predetermined eye action may be pre-set, and is used to be a specified eye action to end the segmentation operation, such as continuously blinking twice or closing eyes, or other actions. The predetermined gesture action may be pre-set, and is used to be a specified gesture action to end the segmentation operation, such as a gesture action “ok” or a making a fist, or other actions. The target segmentation result may refer to a final segmentation result in the target object, that is, a segmentation result which the target user finally wants.

Specifically, after the target user confirms that the presented current segmentation result is the segmentation result needed and is satisfied with the current segmentation result, the segmentation operation may end in a manner of triggering the segmentation end operation, and the current segmentation result is taken as the target segmentation result corresponding to the target object, thereby the user segmentation requirement may be met by a single segmentation.

It should be noted that the target user only needs to view the target wants to segment in the target object, so that real-time segmentation of any target may be achieved, compared with a manner of clicking a mouse or drawing a line drawing, the manner of interactive segmentation with eye viewing is more convenient and rapid, which improves the efficiency of target segmentation, and the accuracy of target segmentation may be ensured by interactive segmentation in conjunction with the visual foundation model.

Exemplarily, after determining the target segmentation result corresponding to the target object, the method may further comprise: taking the target object as a sample object, and taking the corresponding target segmentation result as a sample label to perform model training on the segmentation network model. With the real-time segmentation manner above, the sample mask image mask may be quickly obtained, and sample labeling of the pixel level does not need to be performed manually, thereby improving the efficiency of labeling, and reducing the cost of labeling.

According to the technical solutions of the embodiments of the present disclosure, location information of a current viewpoint when a target user watches a target object is determined, so that the target which the target user currently want to segment is obtained based on the location information of the current viewpoint point. The target segmentation at location of a viewpoint nay be accurately performed based on the visual foundation model, and a current segmentation result is presented to the target user. When the target user is satisfied with the presented current segmentation result, a segmentation end operation may be triggered, and in response to the segmentation end operation, the current segmentation result may be taken as the final target segmentation result of the target object, so that any target that the user wants to segment is real-time segmented, which meets the user segmentation requirement, and the user only needs to watch the target object, there is no need for the user to perform operations such as manual clicking, thereby improving the efficiency of target segmentation.

Based on the foregoing technical solutions, before S130, the method may further comprise: in response to a re-segmentation operation triggered by the target user for the current segmentation result, re-obtaining location information of the current viewpoint of the target user; and performing target re-segmentation based on the re-obtained location information of the current viewpoint.

The re-segmentation operation may be triggered by the target user by performing a predetermined eye action or a predetermined gesture action. Different segmentation operations correspond to different predetermined eye actions or predetermined gesture actions, so that the user triggers different segmentation operations.

Specifically, when the target user confirms that the presented current segmentation result is not a desired segmentation result, and is not satisfied with the current segmentation result, the re-segmentation may be performed by triggering a re-segmentation operation. In response to the target user triggering the re-segmentation operation, the location information of a current viewpoint of the target user may be re-obtained in the manner of returning to the step S110-S120, and the target re-segmentation is performed based on the re-obtained location information of current viewpoint, so that the target user may quickly adjust the segmentation result in a manner of adjusting the viewpoint until the target user triggers the segmentation end operation when the target user is satisfied with the current segmentation result, thereby realizing real-time and rapid interactive segmentation, and meeting user segmentation requirements.

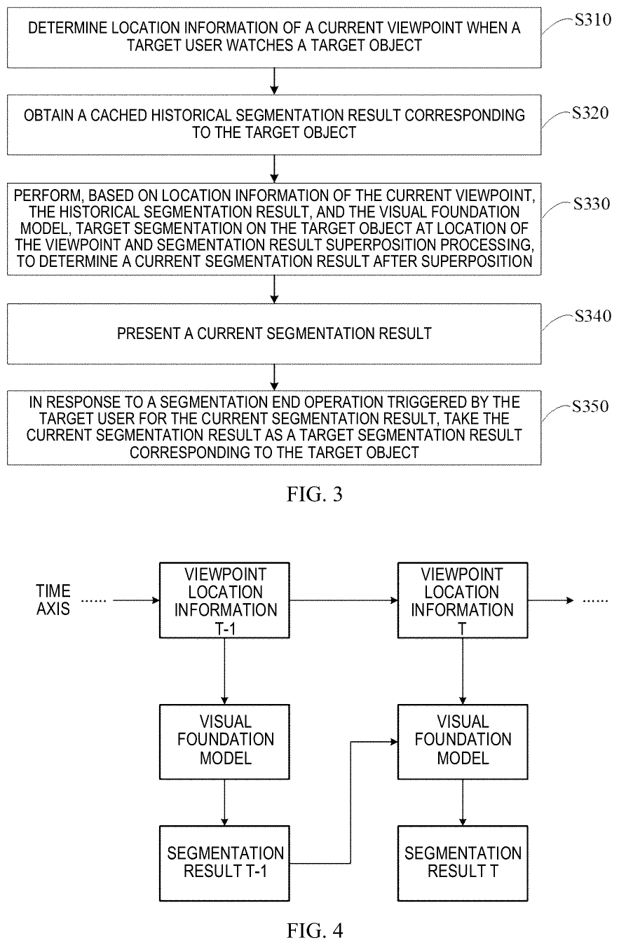

FIG. 3 is a schematic flowchart of another method of target segmentation provided by embodiments of the present disclosure. Based on the above embodiments, the embodiments of the present disclosure describe a target progressive segmentation in details. Explanations of terms that are the same as or corresponding to the above various embodiments of the present disclosure are not described herein again.

As shown in FIG. 3, the method of target segmentation specifically includes the following steps:

S310: Determine location information of a current viewpoint when a target user watches a target object.

S320: Obtain a cached historical segmentation result corresponding to the target object.

The historical segmentation result may refer to a local area that has been segmented from the target object before the current segmentation. For example, the historical segmentation result may refer to a last segmentation result closest to the current moment, so as to continue segmentation based on the last segmentation result. The historical segmentation result may also refer to segmentation result being presented currently, so that the user determines whether to continue segmentation based on the historical segmentation result. The result of each segmentation may be a local area in the target object, so as to perform segmentation as the whole target object by at least two segmentation, thereby achieving the target progressive segmentation.

Specifically, after each segmentation, the result of each segmentation is cached, so that the segmentation may continue on the segmented basis during the next segmentation. When performing the current segmentation on the target object (i.e., the second segmentation or the subsequent segmentation), the cached historical segmentation result of the target object, such as the last segmentation result, may be obtained from the buffer. It should be noted that, if there is no historical segmentation result of the target object in the buffer, it indicates that the target object has not been performed first segmentation currently, at this time, the first segmentation may be performed on the target object directly at the location of the current viewpoint, based on the location information of the current viewpoint of the target user and the visual foundation model, and the result of the first segmentation is cached, so that the second segmentation is performed based on the first segmentation, and so on until the target user is satisfied with the segmentation result.

In an implementation, S320 may comprise: in response to a continued segmentation operation triggered by the target user for the historical segmentation result, obtaining a cached historical segmentation result corresponding to the target object.

The continued segmentation operation may be triggered by the target user by performing a predetermined eye action or a predetermined gesture action. Different segmentation operations correspond to different predetermined eye actions or predetermined gesture actions, so that the user triggers different segmentation operations.

Specifically, when the historical segmentation result currently displayed is only the local area of the target object that the target user wants to segment, the target user may continue segmentation based on the last segmentation by triggering a manner of a continued segmentation operation. In response to a continued segmentation operation triggered by the target user, the cached historical segmentation result corresponding to the target object is allowed to be obtained, so that segmentation is continued subsequently based on the historical segmentation result, thereby the user may actively trigger the continued segmentation operation, and the personalized requirement is met.

As another implementation, S320 may comprise: in accordance with detecting that a condition of continued segmentation is currently satisfied, obtaining the cached historical segmentation result corresponding to the target object.

The condition of a continued segmentation may be a condition that is pre-set based on a service requirement and a scenario, and is currently capable to be a condition of continuing segmentation based on a historical segmentation result. For example, the condition of a continued segmentation may comprise but is not limited to at least one of the following: a variation amount of a current scenario is less than or equals to a first predetermined variation amount; a variation amount of a current eye movement is less than or equals to a second predetermined variation amount; a variation amount of a current head movement is less than or equals to a third predetermined variation amount; and a score of a segmentation quality corresponding to a historical segmentation result is greater than or equals to a predetermined score of a segmentation quality. The variation amount of a current scenario may be determined based on the state of the historical scenario and the state of the current scenario. The state of each scenario may be represented based on a hash value of the video or an image.

Specifically, after the historical segmentation result is presented, if the target user does not trigger the segmentation end operation, then it may be detected whether the condition of continued segmentation is satisfied based on the current, based on the current segmentation information and the historical segmentation information, for example, whether a variation amount of a current scenario is less than or equals to a first predetermined variation amount, whether a variation amount of a current eye movement is less than or equals to a second predetermined variation amount, whether a variation amount of a current head movement is less than or equals to a third predetermined variation amount, and whether a score of a segmentation quality corresponding to a historical segmentation result is greater than or equals to a predetermined score of a segmentation quality, or the like. If it is detected that the condition of continued segmentation is currently satisfied, then it is indicated that the target user wants to continue the segmentation currently, and the requirement of continued segmentation is also met, not a misoperation, so that the cached historical segmentation result corresponding to the target audience may be automatically obtained to continue segmentation, and the user does not need to trigger the continued segmentation operation actively, and the user operation is further simplified.

S330, perform, based on location information of the current viewpoint, the historical segmentation result, and the visual foundation model, target segmentation on the target object at location of the viewpoint and segmentation result superposition processing, to determine a current segmentation result after superposition.

The current segmentation result may refer to a superposition result of each current viewpoint segmentation. For example, the current segmentation result may include a local area of the current viewpoint and a historical segmentation result.

Specifically, as an implementation, the target object and the location information of current viewpoint may be input into the visual foundation model, target segmentation on the target object at the viewpoint location is performed, a single segmentation result output by the visual foundation model is obtained, and perform the superposition processing on the single segmentation result and the historical segmentation result to obtain the current segmentation result after superposition.

As another implementation, the visual foundation model may also allow the input of the segmentation result, so that the segmentation result may also be taken as prompt information for segmentation of the location of the viewpoint, so that the accuracy of the segmentation is further improved, and the superposition processing of the segmentation results may also be directly performed in the model. For example, as shown in FIG. 4, the target object (not shown in FIG. 4), the current viewpoint location information at the time T and the historical segmentation result at the time T−1 may be input into the visual foundation model to perform target segmentation at the viewpoint location and segmentation result superposition processing, and the current segmentation result after superposition is obtained based on the output of the visual foundation model. The visual foundation model may perform segmentation on the target at the current viewpoint location in the target object based on the input of location information of the current viewpoint and the historical segmentation result, and perform superposition on the target after segmentation and the historical segmentation result, and output the segmentation result after superposition. Or, since at each time of segmentation the visual foundation model need to encode the target object to obtain corresponding image vector information, so that after the first segmentation, the image vector information is cached, so that in the subsequent segmentation, only the location information of current viewpoint at the moment T and the historical segmentation result at the moment T−1 may be input into the visual foundation model, in order to make the visual foundation model perform target segmentation more quickly, further reduce the time cost of the segmentation, and improve the efficiency of the segmentation efficiency.

Exemplarily, S330 may comprise: performing time alignment processing on the historical segmentation result, to obtain an aligned historical segmentation result at the current moment; performing, by inputting the target object, location information of the current viewpoint, and an aligned historical segmentation result into the visual foundation model, target segmentation at location of the viewpoint and segmentation result superposition processing; and obtaining, based on output of the visual foundation model, the current segmentation result after superposition.

Specifically, if the target object is a dynamically changing video, before the current segmentation, it is necessary to perform time alignment processing on the historical segmentation result, for example, the historical segmentation result is a mask image of little cat located at the top left corner in the video frame at time T−1, and if the little cat in the current video frame at time T is located at the middle position, then the aligned historical segmentation result is a mask image of the little cat located at the middle position in the video frame at time T, thereby achieving time alignment of the segmentation result, and further ensuring accuracy of superposition of the segmentation result. The visual foundation model may perform segmentation on the target at the current viewpoint location in the target object based on the input of location information of the current viewpoint and the aligned historical segmentation result, and perform superposition on the target after segmentation and the historical segmentation result, and output the segmentation result after segmentation.

It should be noted that, if the target object is a fixed and changeless image, then the wearable device performing time alignment is not needed, the target object, the current location information of viewpoint and the historical segmentation result may be directly input into the visual foundation model to perform target segmentation on the target object at location of the viewpoint and segmentation result superposition processing, and the current segmentation result after superposition is obtained based on the output of the visual foundation model.

S340: present a current segmentation result.

Specifically, the current segmentation result may be labeled in the presented target object, so that the target user may view the segmentation area more intuitively and clearly. If the current segmentation result is not a complete segmentation result, continued segmentation may be performed based on the current segmentation result by the manner of returning back to perform S320-S340, for example, the target user may perform continued segmentation in a manner of triggering a continued segmentation operation for the presented current segmentation result, thereby achieving the progressive segmentation of the target, and achieving the technical effect of “what to watch is what to obtain”.

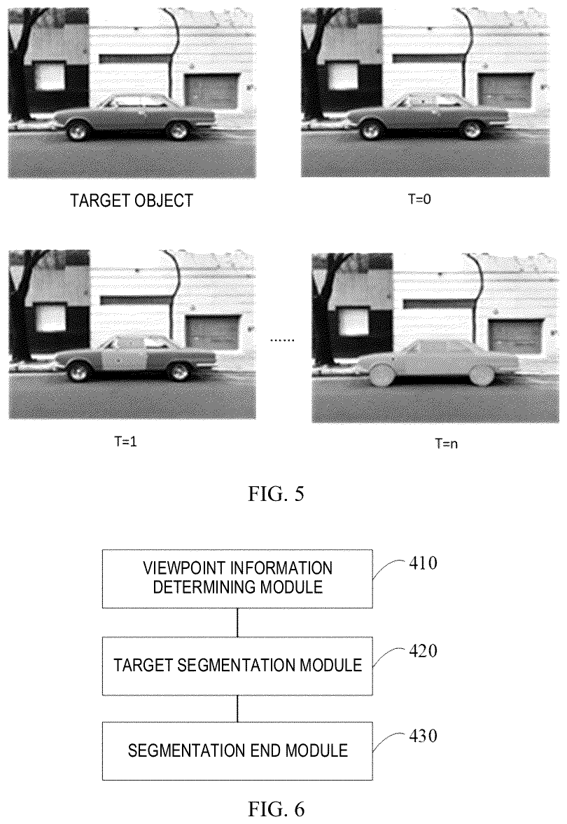

For example, referring to FIG. 5, if completely segmentation needs to perform on the vehicle in the target object, then when T=0 for the first segmentation, the target user may first view the location of the left window of the vehicle, so that the location information of the viewpoint when T=0 is located at the left window of the vehicle (the black dot in FIG. 5 represents the viewpoint), so that the left window area (see the area represented by the grayscale in FIG. 5) may be segmented by using the visual foundation model. When T=1 for the second segmentation, the target user may view the location of the left door of the vehicle, so that the location information of the viewpoint when T=1 is located on the left door, so that the left door area may be segmented by using the visual foundation model, and superposition is performed on the left window area and the left door area to obtain a segmentation result when T=1 (see the area represented by the gray scale in FIG. 5), and so on, the segmentation is performed until the complete vehicle area is segmented when T=n. By viewing all locations in the vehicle one by one, the complete vehicle may be segmented progressively. It should be noted that only one piece of location information of the viewpoint exists during each segmentation, so that accurate segmentation is performed to obtain a final segmentation result desired by the user.

S350: in response to a segmentation end operation triggered by the target user for the current segmentation result, take the current segmentation result as a target segmentation result corresponding to the target object.

Specifically, if the target user is satisfied with the segmentation result of the current segmentation, then may end the segmentation operation in a manner of triggering the segmentation end operation, and the current segmentation result is taken as the target segmentation result corresponding to the target object, thereby realizing finer segmentation by progressive segmentation, and meeting personalized segmentation requirements.

According to the technical solutions of the embodiments of the present disclosure, based on location information of the current viewpoint, the historical segmentation result, and the visual foundation model, target segmentation on the target object at location of the viewpoint and segmentation result superposition processing is performed, so that continued segmentation may be performed based on the historical segmentation result, the target progressive segmentation is achieved, and personalized segmentation requirements are met.

Based on the foregoing technical solutions, before S350, the method may further comprise: in response to a re-segmentation operation triggered by the target user for the current segmentation result, performing clear process on the cached historical segmentation result corresponding to the target object and performing target re-segmentation based on the re-obtained location information of the current viewpoint.

Specifically, when the target user is not satisfied with the current segmentation result of the progressive segmentation, the re-segmentation may be performed by triggering a re-segmentation operation. In response to the re-segmentation operation triggered by the target user, the cached historical segmentation result corresponding to the target object may be deleted to avoid continuing the segmentation based on the historical segmentation result, and the location information of the current viewpoint of the target user is re-obtained, and re-segmentation is performed from the beginning based on the re-obtained location information of current viewpoint, until the target user triggers the segmentation end operation when the target user is satisfied with the current segmentation result, thereby realizing real-time and rapid interactive segmentation, and meeting user's segmentation requirements.

FIG. 6 is a schematic structural diagram of an apparatus of target segmentation provided by embodiments of the present disclosure, as shown in FIG. 6, the apparatus specifically comprises: a viewpoint information determining module 410, a target segmentation module 420, and a segmentation end module 430.

The viewpoint information determining module 410 is configured to determine location information of a current viewpoint when a target user watches a target object; a target segmentation module 420 is configured to perform target segmentation on the target object at location of a viewpoint based on location information of a current viewpoint and a visual foundation model, to determine and present a current segmentation result; and a segmentation end module 430 is configured to, in response to a segmentation end operation triggered by the target user for the current segmentation result, take the current segmentation result as a target segmentation result corresponding to the target object.

According to technical solutions provided by the embodiments of the present disclosure, location information of a current viewpoint when a target user watches a target object is determined, so that the target which the target user currently want to segment is obtained based on the location information of the current viewpoint point. The target segmentation at location of a viewpoint nay be accurately performed based on the visual foundation model, and a current segmentation result is presented to the target user. When the target user is satisfied with the presented current segmentation result, a segmentation end operation may be triggered, and in response to the segmentation end operation, the current segmentation result may be taken as the final target segmentation result of the target object, so that any target that the user wants to segment is real-time segmented, which meets the user segmentation requirement, and the user only needs to watch the target object, there is no need for the user to perform operations such as manual clicking, thereby improving the efficiency of target segmentation.

Based on the above technical solutions, the viewpoint information determining module 410 is specifically configured to:
Obtain current eye movement information or current head movement information when the target user watches the target object via a wearable device; and determine, based on the current eye movement information or the current head movement information, location information of a current viewpoint of the target user.

Based on the above technical solutions, the target segmentation module 420 is specifically configured to:
Label the current segmentation result in the target object presented by the wearable device.

Based on the above technical solutions, the segmentation end operation is triggered by performing a predetermined eye action or a predetermined gesture action by the target user.

Based on the above technical solutions, the apparatus further comprises:
A re-segmentation module, configured to, before in response to the segmentation end operation triggered by the target user for a current segmentation result, in response to a re-segmentation operation triggered by the target user for the current segmentation result, re-obtain location information of the current viewpoint of the target user, and perform target re-segmentation based on the re-obtained location information of the current viewpoint.

Based on the above technical solutions, the target segmentation module 420 comprises:
A historical segmentation result obtaining unit, configured to obtain a cached historical segmentation result corresponding to the target object;
A target segmentation unit, configured to perform, based on location information of the current viewpoint, the historical segmentation result, and the visual foundation model, target segmentation on the target object at location of the viewpoint and segmentation result superposition processing, to determine a current segmentation result after superposition.

Based on the above technical solutions, the historical segmentation result obtaining unit is specifically configured to:
In response to a continued segmentation operation triggered by the target user for the historical segmentation result, obtain a cached historical segmentation result corresponding to the target object; or,
In accordance with detecting that a condition of continued segmentation is currently satisfied, obtain the cached historical segmentation result corresponding to the target object.

Based on the above technical solutions, the condition of continued segmentation comprises at least one of the followings:
A variation amount of a current scenario is less than or equals to a first predetermined variation amount;
A variation amount of a current eye movement is less than or equals to a second predetermined variation amount;
A variation amount of a current head movement is less than or equals to a third predetermined variation amount;
A score of a segmentation quality corresponding to a historical segmentation result is greater than or equals to a predetermined score of a segmentation quality.

Based on the above technical solutions, the target segmentation unit is specifically configured to:
Perform time alignment processing on the historical segmentation result, to obtain an aligned historical segmentation result at the current moment; perform, by inputting the target object, location information of the current viewpoint, and an aligned historical segmentation result into the visual foundation model, target segmentation at location of the viewpoint and segmentation result superposition processing; and obtain, based on output of the visual foundation model, the current segmentation result after superposition.

The apparatus of target segmentation provided by the embodiments of the present disclosure may perform the method of target segmentation provided by any embodiment of the present disclosure, which has functional modules and beneficial effects corresponding to the execution method of target segmentation.

It should be noted that the units and modules comprised in the foregoing apparatus are only divided according to the function logic, but are not limited to the foregoing division, as long as the corresponding functions can be implemented; in addition, the specific names of the various functional units are only for ease of distinguishing, and are not intended to limit the protection scope of the embodiments of the present disclosure.

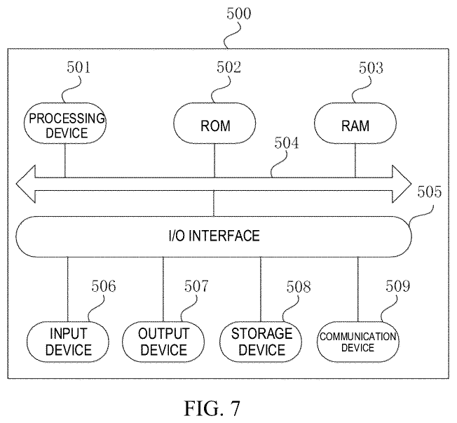

FIG. 7 is a schematic structural diagram of an electronic device provided by embodiments of the present disclosure. Refer to FIG. 7 in the following, which shows a schematic diagram of an electronic device (such as the terminal device or server in FIG. 7) 500 according to an embodiment of the present disclosure. Terminal devices in the embodiments of this application may include, but are not limited to, mobile phones, notebook computers, digital broadcast receivers, PDA (Personal Digital Assistant, personal digital assistant), PAD (tablet computer), PMP (Portable Media Player, portable multimedia players), vehicle-mounted terminals (such as vehicle-mounted navigation terminals), etc., as well as fixed terminals such as digital TV (television, television), desktop computers, etc. The electronic device shown in FIG. 7 is only an example, and should not limit the function and application range of the embodiments of the present disclosure.

As shown in FIG. 7, the electronic device 500 may include a processing device (such as a central processing unit, a graphics processing unit, or the like) 501 that may perform various appropriate actions and processing according to a program stored in a read-only memory (ROM) 502 or a program loaded from a storage device 508 into a random-access memory (RAM) 503. In the RAM 503, various programs and data required for operation of the electronic device 500 are further stored. The processing device 501, the ROM 502, and the RAM 503 are connected to each other by using a bus 504. An input/output (I/O) interface 505 is also connected to the bus 504.

Generally, the following devices may be connected to the I/O interface 505: input device 506 including, for example, a touchscreen, a touchpad, a keyboard, a mouse, a camera, a microphone, an accelerometer, and a gyroscope; output device 507 including, for example, a liquid crystal display (LCD), a loudspeaker and a vibrator; storage device 508 including, for example, a tape or a hard disk; and a communications device 509. The communications device 509 may allow the electronic device 500 to communicate wirelessly or wiredly with another device to exchange data. Although FIG. 7 shows an electronic device 500 with various devices, it should be understood that it is not required to implement or provide all shown devices. Alternatively, more or fewer devices may be implemented or provided.

In particular, according to the embodiments of the present disclosure, the process described above with reference to the flowchart may be implemented as a computer software program. For example, an embodiment of the present disclosure includes a computer software program product that includes a computer program carried on a readable medium, and the computer program includes program codes used to perform the methods shown in the flowchart. In such an embodiment, the computer program may be downloaded and installed from a network by using the communications device 509, or installed from the storage device 508, or installed from the ROM 502. When the computer program is executed by the processing device 501, the foregoing functions defined in the method in the embodiments of the present disclosure are executed.

The names of messages or information interacting between multiple apparatuses in embodiments of the present disclosure are for illustrative purposes only and are not intended to limit the scope of such messages or information.

The electronic device provided by the embodiments of the present disclosure and the method of target segmentation provided in the foregoing embodiments belong to the same inventive concept, and technical details not described in detail in this embodiment may refer to the foregoing embodiments, and this embodiment has the same beneficial effects as the foregoing embodiments.

A computer storage medium is provided by embodiments of the present disclosure, having a computer program stored thereon, and when executed by a processor, the program implements the method of targeting segmentation provided by the foregoing embodiments.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or means, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or means. In addition, in the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, RF (radio frequency), or any suitable combination thereof.

In some embodiments, the client and the server may communicate by using any currently known or future-developed network protocol, for example, an HTTP (Hyper Text Transfer Protocol), and may be interconnected by a communication network of any form or any medium. Examples of the communication network include a local area network (“LAN”), a wide area network (“WAN”), an internet network (for example, the Internet), and an end-to-end network (for example, an ad hoc end-to-end network), and any currently known or future-developed network.

The foregoing computer-readable medium may be included in the foregoing electronic device; it may also exist separately without being assembled into the electronic device.

The foregoing computer-readable medium carries one or more programs, when the foregoing one or more programs are executed by the electronic device, causing the electronic device to: determine location information of a current viewpoint when a target user watches a target object; perform target segmentation on the target object at location of a viewpoint based on location information of a current viewpoint and a visual foundation model, to determine and present a current segmentation result; and in response to a segmentation end operation triggered by the target user for the current segmentation result, take the current segmentation result as a target segmentation result corresponding to the target object.

Computer program codes for performing the operations of the present disclosure may be written in one or more programming languages or a combination thereof, such as object-oriented programming languages Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. Where, the names of these units do not limit the units themselves under certain circumstances, for example, a first obtaining unit may be described as “unit for obtaining at least two Internet protocol addresses”.

The functions described above herein may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM or flash memory), optical fiber, portable compact disk read-only memory (CD-ROM), optical storage device, magnetic storage device, or any suitable combination of the foregoing content.

According to one or more embodiments of the present disclosure, “example 1” provides a method of target segmentation, comprising:
Determining location information of a current viewpoint when a target user watches a target object;
Performing target segmentation on the target object at location of a viewpoint based on location information of a current viewpoint and a visual foundation model, to determine and present a current segmentation result;
In response to a segmentation end operation triggered by the target user for the current segmentation result, taking the current segmentation result as a target segmentation result corresponding to the target object.

According to one or more embodiments of the present disclosure, “example 2” provides a method of target segmentation, further comprising:
Optionally, determining location information of the current viewpoint when the target user watches the target object comprises:
Obtaining current eye movement information or current head movement information when the target user watches the target object via a wearable device;
Determining, based on the current eye movement information or the current head movement information, location information of a current viewpoint of the target user.

According to one or more embodiments of the present disclosure, “example 3” provides a method of target segmentation, further comprising:
Optionally, presenting the current segmentation result comprises:
Labeling the current segmentation result in the target object presented by the wearable device.

According to one or more embodiments of the present disclosure, “example 4” provides a method of target segmentation, further comprising:
Optionally, the segmentation end operation is triggered by performing a predetermined eye action or a predetermined gesture action by the target user.

According to one or more embodiments of the present disclosure, “example 5” provides a method of target segmentation, further comprising:
Optionally, before in response to the segmentation end operation triggered by the target user for a current segmentation result, the method further comprises:
In response to a re-segmentation operation triggered by the target user for the current segmentation result, re-obtaining location information of the current viewpoint of the target user, and performing target re-segmentation based on the re-obtained location information of the current viewpoint.

According to one or more embodiments of the present disclosure, “example 6” provides a method of target segmentation, further comprising:

Optionally, performing target segmentation on the target object at location of a viewpoint based on location information of the current viewpoint and the visual foundation model, to determine the current segmentation result comprise:
Obtaining a cached historical segmentation result corresponding to the target object;
Performing, based on location information of the current viewpoint, the historical segmentation result, and the visual foundation model, target segmentation on the target object at location of the viewpoint and segmentation result superposition processing, to determine a current segmentation result after superposition.

According to one or more embodiments of the present disclosure, “example 7” provides a method of target segmentation, further comprising:
Optionally, obtaining the cached historical segmentation result corresponding to the target object comprises:
In response to a continued segmentation operation triggered by the target user for the historical segmentation result, obtaining a cached historical segmentation result corresponding to the target object; or,
In accordance with detecting that a condition of continued segmentation is currently satisfied, obtaining the cached historical segmentation result corresponding to the target object.

According to one or more embodiments of the present disclosure, “example 8” provides a method of target segmentation, further comprising:
Optionally, the condition of continued segmentation comprises at least one of the following:
A variation amount of a current scenario is less than or equals to a first predetermined variation amount;
A variation amount of a current eye movement is less than or equals to a second predetermined variation amount;
A variation amount of a current head movement is less than or equals to a third predetermined variation amount;
A score of a segmentation quality corresponding to a historical segmentation result is greater than or equals to a predetermined score of a segmentation quality.

According to one or more embodiments of the present disclosure, “example 9” provides a method of target segmentation, further comprising:
Optionally, performing, based on location information of the current viewpoint, the historical segmentation result, and the visual foundation model, target segmentation on the target object at location of the viewpoint and segmentation result superposition processing, to determine the current segmentation result after superposition comprise:
Performing time alignment processing on the historical segmentation result, to obtain an aligned historical segmentation result at the current moment;
Performing, by inputting the target object, location information of the current viewpoint, and an aligned historical segmentation result into the visual foundation model, target segmentation at location of the viewpoint and segmentation result superposition processing;
Obtaining, based on output of the visual foundation model, the current segmentation result after superposition.

According to one or more embodiments of the present disclosure, “example 10” provides an apparatus of target segmentation, comprising:
A viewpoint information determining module, configured to determine location information of a current viewpoint when a target user watches a target object;
A target segmentation module, configured to perform target segmentation on the target object at location of a viewpoint based on location information of a current viewpoint and a visual foundation model, to determine and present a current segmentation result;
A segmentation end module, configured to, in response to a segmentation end operation triggered by the target user for the current segmentation result, take the current segmentation result as a target segmentation result corresponding to the target object.

The above description is only preferred embodiments of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, although the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject has been described using language specific to structural features and/or method logical actions, it should be understood that the subject limited in the appended claims is not necessarily limited to the particular features or actions described above. Rather, the particular features and actions described above are merely example forms of implementing the claims.

I/We claim:

1. A method of target segmentation, comprising:
determining location information of a current viewpoint when a target user watches a target object;
performing target segmentation on the target object at location of a viewpoint based on location information of a current viewpoint and a visual foundation model, to determine and present a current segmentation result; and
in response to a segmentation end operation triggered by the target user for the current segmentation result, taking the current segmentation result as a target segmentation result corresponding to the target object.

2. The method of target segmentation according to claim 1, wherein determining location information of the current viewpoint when the target user watches the target object comprises:
obtaining current eye movement information or current head movement information when the target user watches the target object via a wearable device;
determining, based on the current eye movement information or the current head movement information, location information of a current viewpoint of the target user.

3. The method of target segmentation according to claim 2, wherein presenting the current segmentation result comprises:
labeling the current segmentation result in the target object presented by the wearable device.

4. The method of target segmentation according to claim 1, wherein the segmentation end operation is triggered by performing a predetermined eye action or a predetermined gesture action by the target user.

5. The method of target segmentation according to claim 1, further comprising: before in response to the segmentation end operation triggered by the target user for a current segmentation result,
in response to a re-segmentation operation triggered by the target user for the current segmentation result, re-obtaining location information of the current viewpoint of the target user; and performing target re-segmentation based on the re-obtained location information of the current viewpoint.

6. The method of target segmentation according to claim 1, wherein performing target segmentation on the target object at location of a viewpoint based on location information of the current viewpoint and the visual foundation model, to determine the current segmentation result comprise:
obtaining a cached historical segmentation result corresponding to the target object; and
performing, based on location information of the current viewpoint, the historical segmentation result, and the visual foundation model, target segmentation on the target object at location of the viewpoint and segmentation result superposition processing, to determine a current segmentation result after superposition.

7. The method of target segmentation according to claim 6, wherein obtaining the cached historical segmentation result corresponding to the target object comprises:
in response to a continued segmentation operation triggered by the target user for the historical segmentation result, obtaining a cached historical segmentation result corresponding to the target object; or
in accordance with detecting that a condition of continued segmentation is currently satisfied, obtaining the cached historical segmentation result corresponding to the target object.

8. The method of target segmentation according to claim 7, wherein the condition of continued segmentation comprises at least one of:
a variation amount of a current scenario is less than or equals to a first predetermined variation amount;
a variation amount of a current eye movement is less than or equals to a second predetermined variation amount;
a variation amount of a current head movement is less than or equals to a third predetermined variation amount;
a score of a segmentation quality corresponding to a historical segmentation result is greater than or equals to a predetermined score of a segmentation quality.

9. The method of target segmentation according to claim 6, wherein performing, based on location information of the current viewpoint, the historical segmentation result, and the visual foundation model, target segmentation on the target object at location of the viewpoint and segmentation result superposition processing, to determine the current segmentation result after superposition comprise:
performing time alignment processing on the historical segmentation result, to obtain an aligned historical segmentation result at the current moment;
performing, by inputting the target object, location information of the current viewpoint, and an aligned historical segmentation result into the visual foundation model, target segmentation at location of the viewpoint and segmentation result superposition processing; and
obtaining, based on output of the visual foundation model, the current segmentation result after superposition.

10. An electronic device, comprising:
one or more processors;
a storage apparatus, configured to store one or more programs,
wherein the one or more programs, when executed by the one or more processors, cause the one or more processors to implement acts comprising:
determining location information of a current viewpoint when a target user watches a target object;
performing target segmentation on the target object at location of a viewpoint based on location information of a current viewpoint and a visual foundation model, to determine and present a current segmentation result; and
in response to a segmentation end operation triggered by the target user for the current segmentation result, taking the current segmentation result as a target segmentation result corresponding to the target object.

11. The electronic device of claim 10, wherein determining location information of the current viewpoint when the target user watches the target object comprises:
obtaining current eye movement information or current head movement information when the target user watches the target object via a wearable device;
determining, based on the current eye movement information or the current head movement information, location information of a current viewpoint of the target user.

12. The electronic device of claim 11, wherein presenting the current segmentation result comprises:
labeling the current segmentation result in the target object presented by the wearable device.

13. The electronic device of claim 10, wherein the segmentation end operation is triggered by performing a predetermined eye action or a predetermined gesture action by the target user.

14. The electronic device of claim 10, further comprising: before in response to the segmentation end operation triggered by the target user for a current segmentation result,
in response to a re-segmentation operation triggered by the target user for the current segmentation result, re-obtaining location information of the current viewpoint of the target user; and performing target re-segmentation based on the re-obtained location information of the current viewpoint.

15. The electronic device of claim 10, wherein performing target segmentation on the target object at location of a viewpoint based on location information of the current viewpoint and the visual foundation model, to determine the current segmentation result comprise:
obtaining a cached historical segmentation result corresponding to the target object; and
performing, based on location information of the current viewpoint, the historical segmentation result, and the visual foundation model, target segmentation on the target object at location of the viewpoint and segmentation result superposition processing, to determine a current segmentation result after superposition.

16. The electronic device of claim 15, wherein obtaining the cached historical segmentation result corresponding to the target object comprises:
in response to a continued segmentation operation triggered by the target user for the historical segmentation result, obtaining a cached historical segmentation result corresponding to the target object; or
in accordance with detecting that a condition of continued segmentation is currently satisfied, obtaining the cached historical segmentation result corresponding to the target object.

17. The electronic device of claim 16, wherein the condition of continued segmentation comprises at least one of:
a variation amount of a current scenario is less than or equals to a first predetermined variation amount;
a variation amount of a current eye movement is less than or equals to a second predetermined variation amount;
a variation amount of a current head movement is less than or equals to a third predetermined variation amount;
a score of a segmentation quality corresponding to a historical segmentation result is greater than or equals to a predetermined score of a segmentation quality.

18. The electronic device of claim 15, wherein performing, based on location information of the current viewpoint, the historical segmentation result, and the visual foundation model, target segmentation on the target object at location of the viewpoint and segmentation result superposition processing, to determine the current segmentation result after superposition comprise:
performing time alignment processing on the historical segmentation result, to obtain an aligned historical segmentation result at the current moment;
performing, by inputting the target object, location information of the current viewpoint, and an aligned historical segmentation result into the visual foundation model, target segmentation at location of the viewpoint and segmentation result superposition processing; and
obtaining, based on output of the visual foundation model, the current segmentation result after superposition.

19. A non-transitory storage medium comprising computer-executable instructions, wherein the computer-executable instructions, when executed by a computer processor, are configured to perform acts comprising:
determining location information of a current viewpoint when a target user watches a target object;
performing target segmentation on the target object at location of a viewpoint based on location information of a current viewpoint and a visual foundation model, to determine and present a current segmentation result; and
in response to a segmentation end operation triggered by the target user for the current segmentation result, taking the current segmentation result as a target segmentation result corresponding to the target object.

20. The non-transitory storage medium of claim 19, wherein determining location information of the current viewpoint when the target user watches the target object comprises:
obtaining current eye movement information or current head movement information when the target user watches the target object via a wearable device;
determining, based on the current eye movement information or the current head movement information, location information of a current viewpoint of the target user.
